(19) United States
(12) Patent Application Publication
(10) Pub. No.: US 2013/0282614 A1
(43) Pub. Date: Oct. 24, 2013

(54) Method and Apparatus of Determining Funded Status Volatility

(71) Applicant: NISA INVESTMENT ADVISORS, L.L.C., St. Louis, MO (US)

(72) Inventors: Daniel Arthur Scholz, Clayton, MO (US); Richard Robert Ratkowski, II, St. Charles, MO (US)

(73) Assignee: NISA INVESTMENT ADVISORS, L.L.C., St. Louis, MO (US)

(21) Appl. No.: 13/797,000

(22) Filed: Mar. 12, 2013

Related U.S. Application Data
(60) Provisional application No. 61/636,033, filed on Apr. 20, 2012.

(51) Int. Cl. G06Q 40/06

(52) U.S. Cl. CPC G06Q 40/06
USPC 705/36 R

(57) ABSTRACT

A volatility level associated with the funding level of a fund may be assessed with a memory and a processor. The processor is configured to store a plurality of data structures in memory. The data structures comprises a plurality of data items associated together as volatility measures, correlation measures that corresponds to correlation of the asset returns within the fund, duration measures that are related to the volatility measures, and holdings in the fund. The processor determines an asset class volatility measure based in part upon the volatility measures, the correlation measures, the duration measures, and the holding in the fund. The processor also determines a liability measure associated with the fund, a holding volatility measure based upon the asset class volatility measure and the percentage weight of the holding in the fund. The processor calculates a funded status volatility by comparing the holding volatility measure to the liability measure.

### RELATED APPLICATION DATA

This application claims the benefit of provisional application Ser. No. 61/636,033 filed Apr. 20, 2012, the disclosure of which is incorporated by reference herein.

### BACKGROUND AND SUMMARY

During the end of 2011 the negative performance of most risk assets, coupled with dramatically lower interest rates, has had the obvious effect of reducing funded status for most corporate defined benefit pension plans. Though perhaps less obvious, dramatically higher prospective volatilities have material implications for both asset allocation and interest rate hedging strategies.

Many U.S. pension plans experienced a drop in funded status in 2010 and 2011. The funded status of some plans fell substantially. During 2010 and 2011, liability discount rates were 75 basis points (“bps”) lower and global equity values were down by approximately 15%. In total, the average pension plan saw a decline of 10%-20% in its funded status in the third quarter of 2011. In the same period, there was an increase in the expected funded status volatility—as much as 70%.

Because asset allocation targets are generally set, in part, based on expected funded status volatility, a change of this magnitude may move a plan outside its intended funded status risk budget. Common rebalancing rules are likely to exacerbate this issue, both because of an increase in risk assets as well as a decrease in the portion of the liability being hedged, due to a reduction in fixed income. Market conditions as experienced in 2010 and 2011 warrant an effective way to adjust to increased market risks.

Understanding pension plan risk requires a parallel appreciation of volatility estimates for both assets and liabilities. The key drivers of funded status volatility are derived from estimates of general interest rate volatility, spread volatility and risk asset (e.g., equity) volatility. For ease of exposition, in the examples that follow, a hypothetical fully funded plan with a 60% allocation to global equity and a 40% allocation to long government assets and long credit assets is described. Estimates of prospective, annualized funded status volatility for this hypothetical plan since 1999 are illustrated in FIG. 18. “Prospective Funded Status Volatility” measures expected future volatility rather than historical volatility. To this end, option market implied volatilities are used to estimate the market's future risk. The absence of a liquid market for correlations requires use of historical correlation estimates to provide a prospective estimate of funded status volatility. FIG. 19 is a chart of Prospective Funded Status Volatility since Sep. 30, 2009. As shown in the graph of FIG. 19, funded status volatility increased dramatically from Q2 to Q3 2011. In fact, plan wide volatility increased approximately 70% from lows of approximately 13% in May 2011. Based upon September 2011 levels, a one standard deviation movement in funded status over the next year would be +/−22% (of plan liabilities). In other words, a plan with a deficit of 20% would have a 1 in 3 chance of seeing the deficit either eliminated or more than doubled over the next year.

To provide another perspective, there would need to be substantial changes in asset allocation to reestablish a funded status volatility of 13%. As shown in the example of FIG. 20, reallocating 25% from risk assets to long bonds would be required to maintain a funded status volatility of 13% (see arrow A (FIG. 20)). At the September 2011 volatility levels, a 40% reallocation from bonds to risk assets would be required (see arrow B (FIG. 20)). Plan fiduciaries would be unlikely to approve a 25-40% shift in asset allocation and a 70% increase in funded status volatility without careful study. This seems true even if expected return increased correspondingly. Perhaps similar attention should be given to an equivalent change in risk due to changes in market conditions. Rebalancing rules that target specified asset allocations can result in dramatically different risk profiles, depending on prevailing risk estimates. To the extent current volatility measures are radically different (either higher or lower) from when policies were set, adjustments in target asset allocations may very well be warranted under these circumstances. With this in mind, a system may be configured to generate an index that may be used to quantify funded status volatility.

### DESCRIPTION OF THE DRAWINGS

FIG. 1 is a schematic diagram of a system for developing an index to quantify funded status volatility.

FIG. 2 shows a high level flowchart of operation of the system.

FIG. 3A shows an exemplary application wherein data from multiple sources is transmitted to a server and compiled in a database or other electronic storage media.

FIG. 3B shows an exemplary data structure for the database.

FIG. 4 shows an application wherein workstation accesses market financial data from a database or other electronic storage media and displays the information on a graphic user interface associated with the workstation.

FIG. 5 shows an exemplary data computation of a server that may be displayed at a workstation relating to the input volatilities.

FIG. 6 shows an exemplary data computation of a server that may be displayed at workstation relating to input correlation data.

FIG. 7 shows an alternative embodiment of the display of FIG. 5 in the form of a chart listing data for a specific date.

FIG. 8 shows an alternative embodiment of the display of FIG. 6 in the form of a chart with data for a specific date.

FIGS. 9-12 show exemplary displays that may be displayed at a workstation to show data associated with the steps in building the asset classes.

FIG. 13 shows an exemplary display of the correlation factors associated with the liability and the portfolio asset classes in the form of a chart for a specified date.

FIG. 14 shows an alternative embodiment of the display of FIG. 13 in a graphical form.

FIG. 15 shows an exemplary display in chart form for a specific date resulting in the volatility for the portfolio and liability, for an illustrative weighting of the asset class.

FIG. 16 shows an exemplary display in graphical form resultant volatilities associated with the portfolio, the liability, and funded status.

FIG. 17 shows an exemplary display in chart form the resultant index of funded status volatility that may be transmitted to users via the system. \

FIG. 18 illustrates estimates of prospective, annualized funded status volatility for a hypothetical plan since 1999.

FIG. 19 is a chart of Prospective Funded Status Volatility since Sep. 30, 2009.

FIG. 20 shows an example of reallocating risk associated with a hypothetical plan.

### DETAILED DESCRIPTION

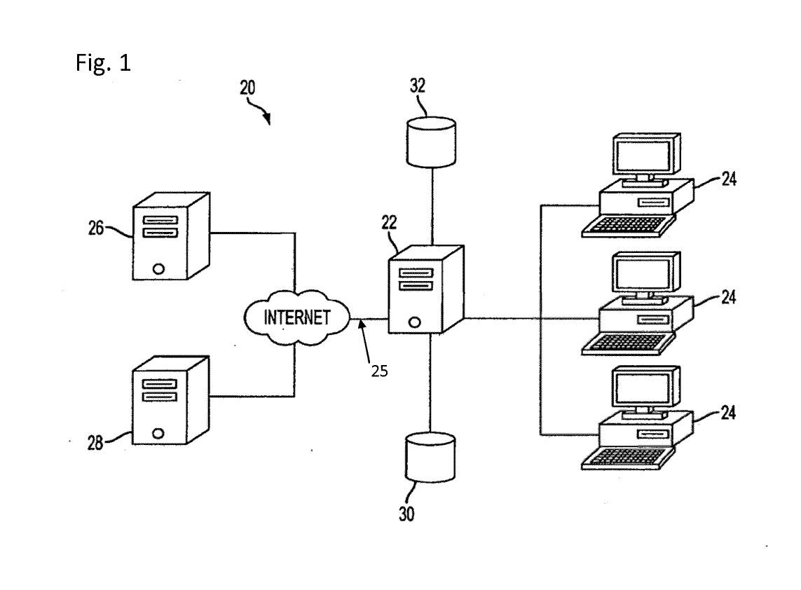

Referring now to FIG. 1, a schematic diagram of a system 20 is shown for identifying one or more securities or financial market data or analysis thereof from third party providers, subscription sources, and/or governmental sources in order to develop an index to quantify funded status volatility. The system 20 includes a server 22 in communication with one or more user workstations 24, for example, via a direct data link connection or a network 25 such as a local area network (LAN), an intranet, or the Internet. The server 22 and the work stations 24 can be computers of any type so long as they are capable of performing their respective functions as described herein. The computers may be the same, or different from one another, but preferably each have at least one processor and at least one memory device capable of storing a set of machine readable instructions (i.e., computer software) executable by at least one processor to perform the desired functions, where by “memory device” is meant any type of media or device for storing information in a digital format on a permanent or temporary basis such as, for example, a magnetic hard disk, flash memory, an optical disk, random access memory (RAM), etc.

Each workstation 24 (or a remote computer) may take the form of any computer or other device capable of connecting to the network to support the type of data interactions and data processing described herein. For example, the workstation 24 can be a standard personal computer (PC) or laptop capable of connecting to the Internet or other data communications network, and optionally including a conventional web browser program (such as Internet Explorer). As another example, the workstation 24 can be a mobile computing device such as a smart phone (e.g., an iPhone, a Google Android device, a Blackberry device, etc.), a tablet computer (e.g., an iPad), or the like.

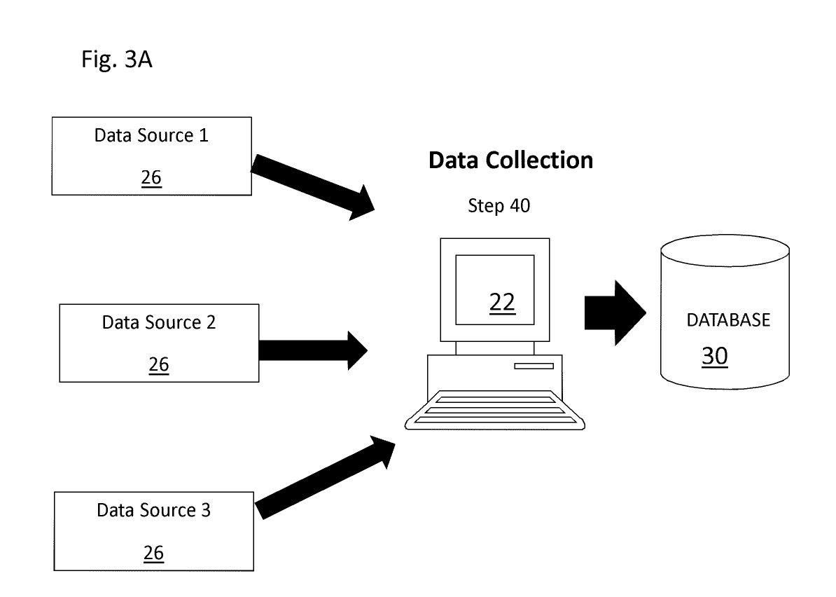

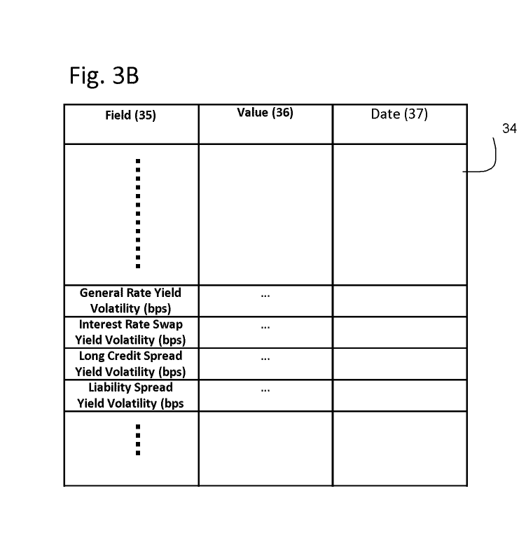

The computer software stored on the server (“server software”), when executed by the server's processor, causes the server 22 to communicate with the workstations 24 and one or more remote sources 26,28 of financial data, such as data vendors, that offer real-time securities data, and market financial information and analysis in an electronic format. The server software, when executed by the server's processor, also causes the server 22 to perform certain calculations, described in greater detail below, using the real-time data from the data vendors 26,28, as well as historical data about the securities and financial market data, to one or more workstations 24. FIG. 3A shows an exemplary application wherein data from multiple sources is transmitted to a server and compiled in a database or other manipulatable electronic storage media. Securities, financial and market data used by the system 20 may be received from a remote source 26,28, such as a data vendor, or from a local database 30 connected to, or maintained on, the server 22. Other financial data may be stored in a database 32 maintained on, or otherwise accessible, by the server 22.

A processor may be resident on a server 22, where the server 22 is configured to communicate with the data sources 26,28, the databases 30,32, and the workstations 24 via the network. The server 22 may be configured to host a website through which the workstations 24 access the functionality described herein. It should also be understood that the server 22 can be configured to host a mobile application site through which the remote workstations can access the functionality described herein. Further still, it should be understood that the processor of the server 22 may comprise multiple processors for performing the functionality described herein in a distributed manner, and that the server may comprise multiple servers. Programming may include programming on one or multiple processors for performing the functionality described herein in a distributed manner.

The memory and databases 30,32 can be resident on any of one or more physical memories that can take the form of a non-transitory computer-readable storage medium. Such memory can be configured to store data structures representative of the profiles described herein as well as data structures representative of the executable programming instructions described herein. For example, the memory may take the form of RAM within a server and the memory for databases 30,32 may take the form of a hard drive or the like within the server or accessible by the server. Further still, it should be understood that database 30,32 may optionally be distributed across multiple physical memories as a plurality of databases. Moreover, the content of the database 30,32 is preferably encrypted to protect the privacy and security of any data stored therein.

It should be noted that the system described herein may be implemented in software and/or in a combination of software and hardware, e.g., using application specific integrated circuits (ASIC), a general purpose computer or any other hardware equivalents. Programming for the system and/or mobile device may be loaded into memory and executed by processor to implement the functions discussed herein. As such, programming may be stored on a computer readable medium, e.g., RAM memory, magnetic or optical drive or diskette and the like. Further as used herein, the term “pmgram” or “programming” refers to computer program logic utilized to provide the specified functionality. Thus, a program or programming may be implemented in hardware, firmware and/or software.

FIG. 3(b) shows an exemplary data structure 34 associated with securities, financial and market data used by the system 20. The data structure 34 is stored in the memory associated with the processor. The data structure comprises a plurality of data items 35,36,37 associated together as indices reflecting relative volatility. Similar data structures with more or less fields may be created and associated with securities, financial and market data used by the system 20, as will be described in greater detail below. The information shown in the drawing figures is intended to be exemplary and not limiting in any fashion.

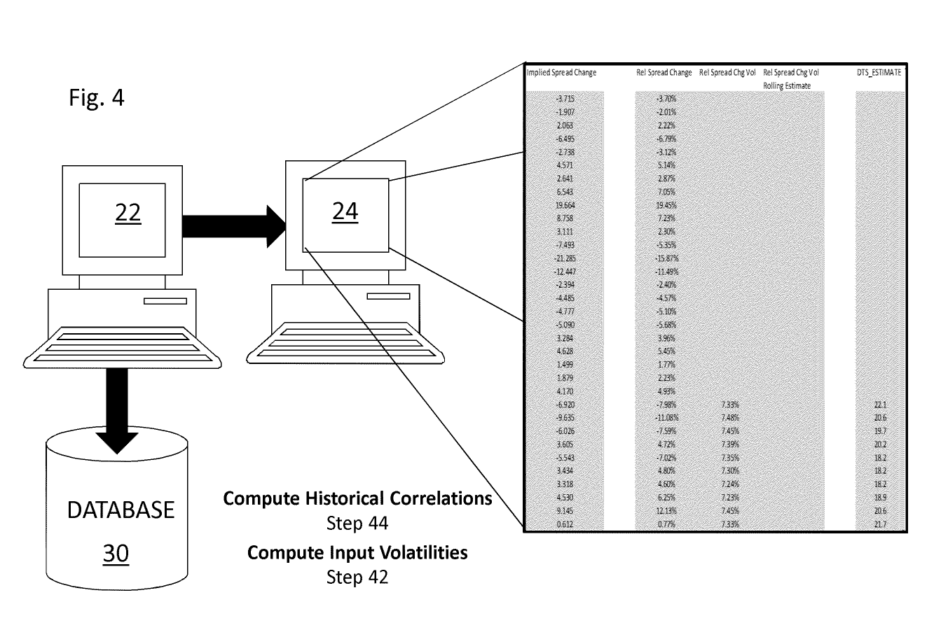

The computer software stored on a workstation (“user software”), when executed by the workstation processor, causes the workstation 24 to receive indicators from the server 22 and to display the indicators to a user on a monitor, for example using a spreadsheet program or portfolio management and optimization programs, or other types of computer programs capable of measuring and manipulating market financial data. FIG. 4 shows an exemplary application wherein workstation 24 accesses market financial data from the database 30 and displays the information on a graphic user interface associated with the workstation.

The server 22 can be located at the user's facility or at a site remote from the user's facility. Communication between the server 22 and the data vendors 26 and 28 can be accomplished via a direct data link connection or a network, such as a LAN, an intranet or the Internet. In alternate embodiments, one or more workstations can be configured to perform the server functions such that a dedicated server is not needed. It will also be appreciated that workstations can be configured to communicate individually with data vendors and/or local databases without being networked to a server or other workstations.

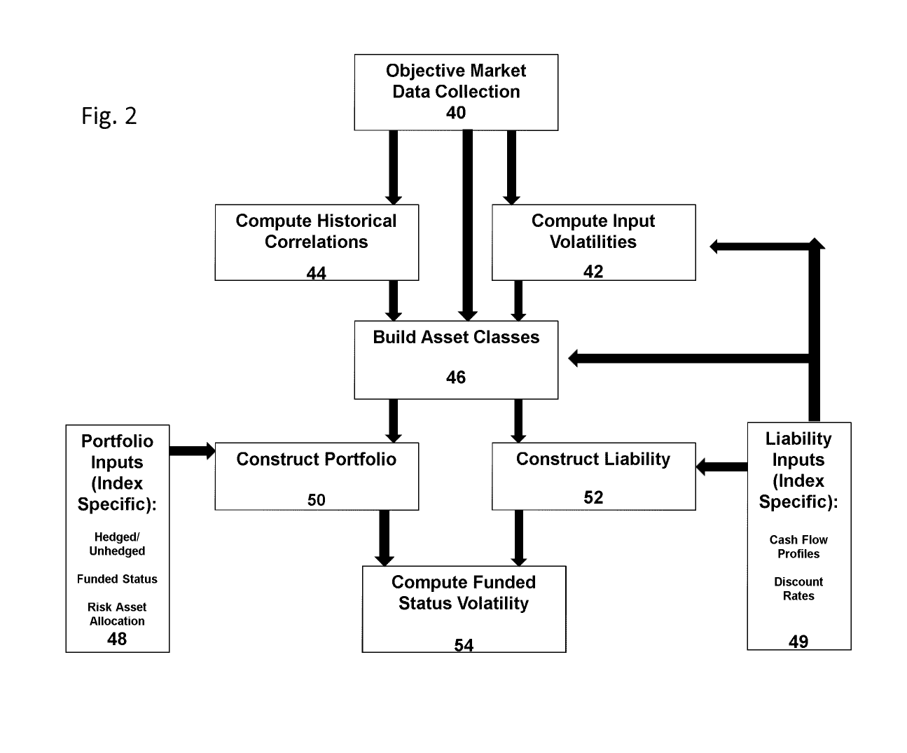

Operation of the system 20 is described with reference to the flow chart shown in FIG. 2. Generally speaking, the funded status of a defined benefit pension plan is defined as the difference between the amount of assets the plan has and the value of the liabilities for which the plan is responsible. An index may be used to provide a measure of the volatility of this difference. Particularly important is that the index is calculated using data that provides a better forward looking estimate of this volatility, rather than measuring what the volatility historically has been.

The first set in the process as indicated by block 40 is collect data. As mentioned above, securities, financial and market data used by the system 20 may be received from a remote source 20, such as a data vendor, or from a local database 30 connected to, or maintained on, the server 22. Other financial data may be stored in a database 32 maintained on, or otherwise accessible, by the server 22. At step 42, the system receives from a remote source, such as a data vendor, real-time values of one or more variables associated with input volatilities, and stores at least some of the values in memory. The nature of the input volatility information collected, computed and stored is discussed below in greater detail. Some of the volatility data may be based upon user assumptions or other generated parameters, for instance, analysis of cash flow, etc., as will be described below with respect to step 49. Other volatility measures may be based upon observed market data and/or historical analysis, and may be provided directly from financial market data sources as described above with respect to step 40. In a preferred embodiment, values are received at the close of the trading day, although the system may be configured to receive the information continuously in real-time throughout a trading day. Some of these values (e.g., values received at predetermined intervals) are used to calculate certain analytics as described in greater detail below. In addition, at least some of the real-time values may optionally be stored in a database on the server or elsewhere for later reference as historical data.

At step 44, the system receives historical data on selected asset performance, volatilities and other relevant historical information for use in calculating correlations. The historical data can be received from one or more remote or local sources whenever it is needed, but is preferably received at predetermined intervals throughout the day. In a preferred embodiment, at least some of the historical data is maintained in a database on the server and updated daily. At the beginning of the trading day, the historical data in the database may be uploaded into memory so that it can be accessed immediately by the system at any time during the trading day. Alternatively, all or some of the historical data may be received from a remote source, such as a data vendor.

At step 46, the system receives correlations and volatilities determined in steps 44 and 42, and certain assumptions and user generated parameters to assist the user evaluating the asset classes. As will be described in greater detail below, a weighting scheme is applied to compute the asset classes based upon volatility, correlation, and duration factors. Some of the factors used for duration factors may be based upon user generated parameters of cash flow analysis, discount rate, etc., as will be described below with respect to step 49. Other duration factors may be based upon observed market data and historical analysis, and may be provided directly from financial market data sources as described above with respect to step 40.

At step 48, the system receives portfolio inputs that are pension surplus volatility index specific and may relate to funded status, risk asset allocation preferences, and hedging strategies. Funded status may be defined as a percent based upon the amount of assets divided by the value of liabilities. A common assumption may be to use 100% (1.0), but other percentages (values) may be used to evaluate asset allocation among other factors. Hedging strategies may involve whether or not all interest rate risk from the liability will be hedged by the portfolio. Risk asset allocation may be a factor corresponding to the amount of risk assets in the portfolio.

At step 50, the system receives the asset class data computed at step 46 and portfolio inputs computed at step 48. The system applies the asset class data and portfolio inputs to the portfolio holdings based upon the percentage weight of each holding.

At step 49, the system receives liability inputs that may be pension surplus volatility index specific and relate to cash flow profiles of liabilities and the definition of the discount rate used to value those cash flows.

At step 52, the system receives the asset class data computed at step 46 and liability input from step 49 and applies the data to the liability asset class.

At step 54, the system calculates funded status volatility and transmits the index to user computers 24 throughout the system as may be desired. As will be explained in greater detail below, the funded status volatility is determined by the statistical subtraction of the portfolio and the liability.

While steps 42 and 44, and 50 and 52, are shown in FIG. 2 as being performed in parallel, it will be appreciated that two or more of these steps can be performed serially in any order.

Expanding upon the process and the elements of the system 20 and shown in FIG. 2, at step 42, the system computes input volatilities. Depending upon what market risks may be present in the pension plan, the input volatilities may include any of the following: (i) general rate volatility; (ii) fixed-income portfolio spread volatility; (iii) liability spread volatility; (iv) US large cap equity volatility; (v) US small cap equity volatility; (vi) international equity volatility; (vii) emerging market equity volatility; (viii) real estate volatility; (ix) hedge fund volatility; (x) private equity volatility; (xi) interest rate swap volatility; and (xii) longevity volatility. This is intended to be an exemplary list and not limiting in any sense. Each of these volatility inputs will be described in greater detail below.

General rate volatility may itself be a composite of the three (3) month implied U.S. Treasury volatility and the one (1) year implied U.S. Treasury volatility. The three (3) month implied U.S. Treasury volatility may be calculated by using market observed prices for three (3) month at-the-money thirty (30) year U.S. Treasury options in conjunction with the duration of the current thirty (30) year bellwether.

The one (1) year implied U.S. Treasury volatility may be calculated by using the three (3) month implied U.S. Treasury volatility and the observed volatility term structure in comparable Swaption markets, to imply the twelve (12) month at-the-money thirty (30) year U.S. Treasury volatility. For example, in calculating the one (1) year implied U.S. Treasury volatility, if the three (3) month, thirty (30) year Swaptions have a volatility of 80 bps, and the twelve (12) month, thirty (30) year Swaptions have a volatility of 88 bps, a ten (10%) increase to the three (3) month implied U.S. Treasury volatility may be implied, such that the one (1) year implied U.S. Treasury volatility may be estimated to be 10% greater than the three (3) month implied U.S. Treasury volatility, as calculated above. In constructing the index rate volatilities associated with multiple volatilities may be used to match the duration of the fixed income portfolio.

Fixed-Income portfolio spread volatility is computed using the current spread and historical percent spread volatility. First, the standard deviation of relative option-adjusted spread (“OAS”) changes may be computed, for instance, as OAS Change/OAS in the prior period. A five year monthly history may be used for computing the standard deviation. The result is then multiplied by the prevailing OAS level and then annualized to calculate the portfolio spread volatility. In constructing the index, a separate fixed-income spread volatility may be calculated for each fixed income asset class identified. Data structures similar to those described in FIG. 3(b) may be constructed for each separate fixed-income spread volatility and associated with each fixed income asset class identified.

The liability spread volatility may be computed using a method similar to portfolio spread volatility as described above. However, the OAS of the liability needs to be calculated. In one example, the OAS of the liability for the period may be determined by (i) calculating the internal rate of return (IRR) of the liability via the selected pension liability discount curve; (ii) calculating the IRR of the liability using the U.S. Treasury curve; (iii) determining the differences of the yields to arrive at the OAS for the period. Data structures similar to those described in FIG. 3(b) may be constructed for the OAS of the liability and associated with each fixed income asset class identified.

The twelve (12) month implied domestic (US) large cap & small cap equity volatility may be based on the domestic large & small cap equity option market. Both international and emerging market equity volatility may also be based on those underlying markets, if available. In the event those markets are not directly observable, option markets on exchange traded funds (ETFs) with similar exposures to international and emerging equity markets may be used to determine the appropriate volatility. Although volatilities are not directly observable standard quantitative techniques are used (Black-Scholes option pricing formula) to determine market implied volatilities from market prices.

Option markets, on hedge funds and real estate investments may not be easily observable. Because of this, the twelve (12) month volatility may alternatively be based on a ratio of historical volatility (using five (5) years of data) of a broad based hedge fund (or real estate) index to a US large cap equity index. The twelve (12) month prospective volatility may then be calculated by first determining the one (1) year US large cap equity market at-the-money implied option volatility and multiplying by the historical volatility ratio of the hedge fund (or real estate)/US large cap equity indices. The respective data structure may be constructed and stored in the database.

The private equity market is difficult to observe. Very few published indices exist on this market, and virtually no liquid instruments are available for trading. Private equity has qualitative characteristics that may be similar to the US small cap equity market. For the purpose of determining volatility on private equity a historical beta between private equity (using published private equity indices) and small cap equity is estimated. The domestic small cap equity volatility is then scaled by the private equity beta for determining the private equity volatility.

σ_{PE}=β_{PE}σ_{USSC}

Interest rate swap spread volatility is generally only needed on hedged indices. The interest rate swap spread volatility may be determined using the implied U.S. Treasury volatility, Swaption Implied Volatility, and the historical correlation between general rate movements and changes in swap spreads as described in detail below. The volatility of interest rate swap spreads (σ_{IR Spread}) may be solved for using the following equation:

σ²_{IR}=σ²_{Tsy}+σ²_{IR Spread}+2σ_{IR Spread}σ_{Tsy}ρ_{Tsy,IR Spread}

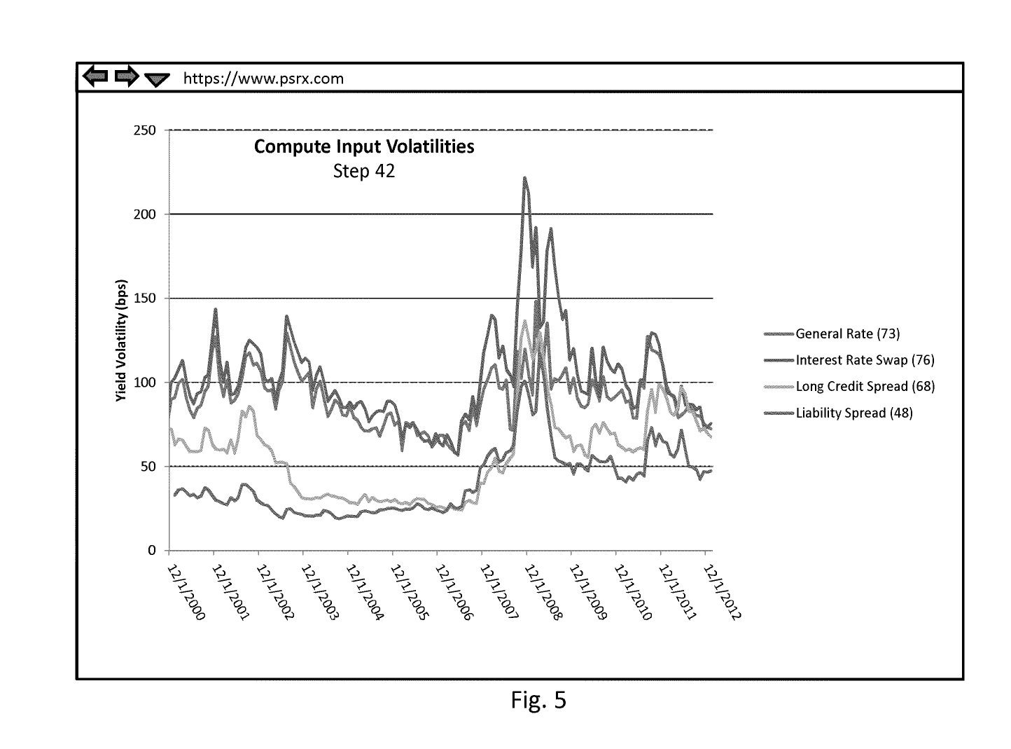

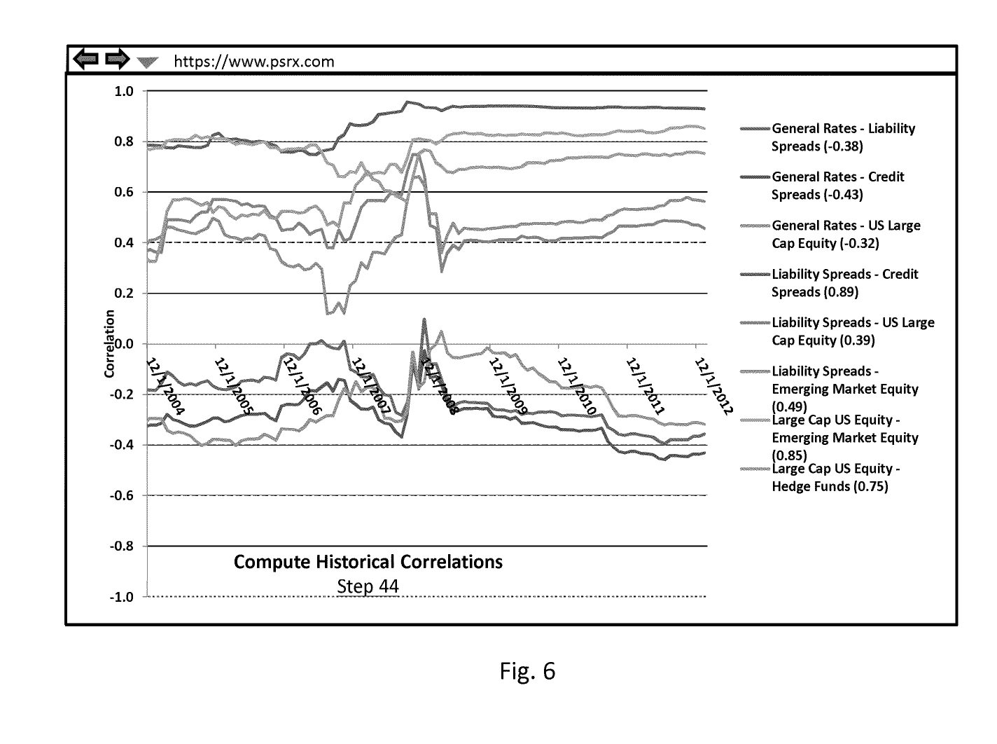

The terms σ²_{IR}, σ²_{Tsy} and σ_{Tsy} may be calculated from step 42 (FIGS. 5,7). The term ρ_{Tsy,IR Spread} may be calculated from step 44 (FIG. 6,8). The above equation can be undefined at times. When this occurs the correlation may be changed to the closest historical correlation level.

Longevity volatility is the uncertainty embedded in longevity assumptions used for calculating plan benefits. Current actuarial practice does not account for uncertainty in longevity assumptions. Longevity risk has the potential to increase (or decrease) the value of the liability as pensioners live longer (or shorter) than anticipated. In the current system, longevity risk is not included as part of the funded status volatility measure, but could be in the future.

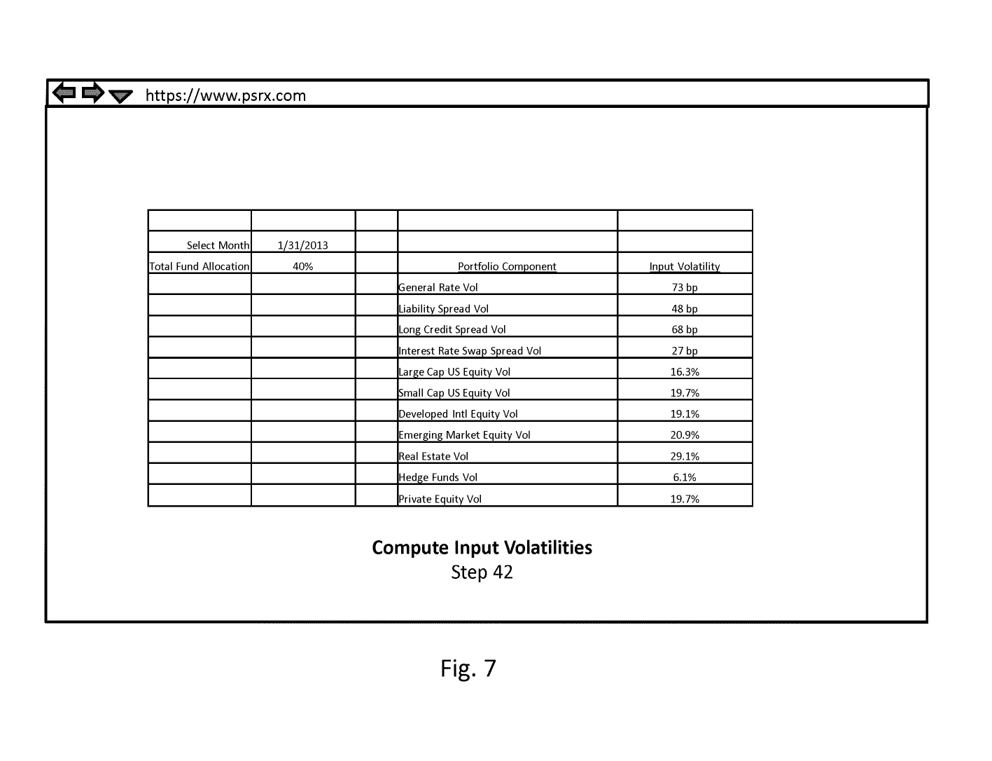

FIG. 5 shows an exemplary data computation of the server 22 that may be displayed at workstation 24 relating to the input volatilities. FIG. 5 shows a graph of general U.S. Treasury volatility, long credit spread volatility, interest rate swap volatility and liability spread volatility over a period of time. FIG. 7 shows an alternate display in the form of a chart listing data for a specific date. Software on the workstation 24 may be configured to access the server 22 and display a variety of information to the user on a display of the workstation as may be desired by the user, including in dashboard format. Thus, the displays represented in FIGS. 5 and 7 are intended to be exemplary. FIGS. 5 and 7 show volatility calculations prior to application of the weighting scheme and duration factors. For instance, as shown in the FIGS. 5 and 7, the yield volatility values are: U.S. Treasury rate volatility (i.e., general rate) (73), liability spread volatility (48), long credit spread volatility (68); and interest rate swap volatility (76).

After input volatilities are calculated (FIG. 2; step 42), historical correlations are computed at step 44. The correlations may be computed using a five (5) year history, but this is intended to be exemplary and not limiting in any sense. The historical correlations may include the correlation and cross correlations of:
General rate returns
Liability spread returns
Fixed-Income spread returns
US large cap equity returns
US small cap equity returns
International equity returns
Emerging market equity returns
Real estate returns
Hedge fund returns

The correlation of general rate movements to credit spread movements may be based upon the excess return of a long credit portfolio and/or the total return on a long credit portfolio less the excess return of the long credit portfolio. The correlation of general rate movements to liability spread movements may be based upon the excess return of a liability portfolio, and/or excess return on the liability less the total return on the liability. The correlation of liability spread movements to credit spread movements may be based upon the excess return of the liability and/or the excess return of the long credit portfolio. Other asset correlations may be computed using a US large cap equity total return index, US small cap equity total return index, international equity total return index, and emerging market equity total return index, broad based hedge fund total return index, real estate total return index, the excess return of the long credit portfolio, the excess return of the liability, and/or U.S. Treasury market (general rate) returns. Swap spread correlations may be computed using data for a 30 year swap excess return (or other relevant tenor).

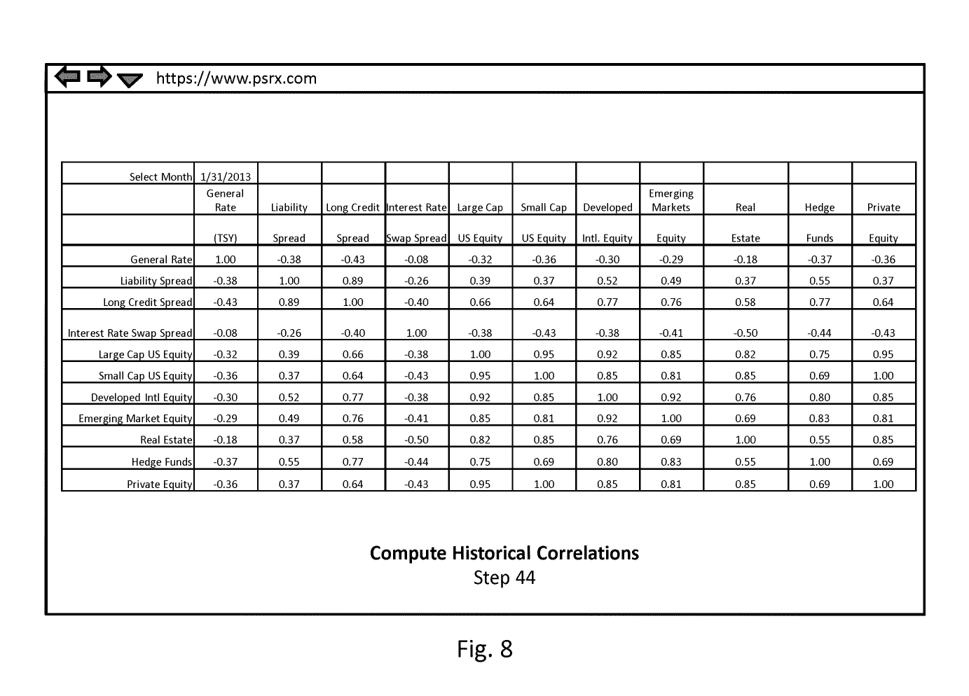

FIG. 6 shows an exemplary data computation of the server 22 that may be displayed at workstation 24 relating to input correlation data. FIG. 6 shows a graph of the correlation values that may be applied in computing the funded status volatility index in a manner as discussed below. For example, correlations having a positive value on Jan. 31, 2013 include (in lower positive value): long credit spreads to liability spreads; large cap US equity to emerging market equity; large cap US equity to Hedge funds; liability spreads to emerging market equity; and liability spreads to US large cap equity; and correlations having a negative value on Jan. 31, 2013 include (in greater negative value): general rates to US large cap equity; general rates to liability spreads; and general rates to swap spreads; liability spreads to swap spreads; swap spreads to equity; and general rates to long credit spreads. FIG. 6 is not an exhaustive list of all correlations required to compute the funded status volatility. FIG. 8 shows an alternate display in the form of a chart with data for a specific date. Software on the workstation 24 may be configured to access the server 22 and display a variety of information to the user on a display of the workstation as may be desired by the user, including in dashboard format. Thus, the display represented in FIGS. 6 and 8 are intended to be exemplary.

Referring to FIG. 2, at step 46, the asset classes are built. The liability asset class is built with an equal weighting of the general rate volatility and liability spread volatility as computed above with the application of a duration factor. The following equation may be used to compute volatility associated with the liability asset class.

σ²_{L}=σ²_{Tsy}D²_{L}+σ²_{LSpread}D²_{L}+2σ_{LSpread}σ_{Tsy}D_{L}D_{L}ρ_{TsyLiab,LSpread}

The terms σ²_{Tsy}, σ²_{LSpread}, σ_{LSpread}, σ_{Tsy} may be calculated from step 42 (FIGS. 5,7). The term ρ_{TsyLiab,LSpread} may be calculated from step 44 (FIGS. 6,8). The duration factor of the liability asset class (D_{L}) is the duration of the liability as supplied by Step 49.

The long credit portfolio asset class is built with an equal weighting of the general rate volatility and long credit spread volatility with application of a duration factor. The following equation may be used to compute volatility associated with the long credit portfolio asset class.

$${σ}_{LC}^{2} = {σ}_{Tsy}^{2} {D}_{LC}^{2} + {σ}_{LCSpread}^{2} {D}_{LC}^{2} + 2 {σ}_{LCSpread} {σ}_{Tsy} {D}_{LC} {D}_{LC} {ρ}_{TsyLC , LSpread}$$

The terms σ²_{Tsy}, σ²_{LCSpread}, σ_{LCSpread}, σ_{Tsy} may be calculated from step 42 (FIGS. 5,7). The term ρ_{TsyLC,LSpread} may be calculated from step 44 (FIGS. 6,8). The duration factor for the long credit portfolio asset class (D_{LC}) is the duration of a long credit type index from step 40.

The long U.S. Treasury portfolio asset class is built using the general rate volatility with application of a duration factor. The following equation may be used to compute volatility associated with the long U.S. Treasury portfolio asset class.

σ²_{LTreas}=σ²_{Tsy}D²_{LTreas}

The term σ²_{Tsy} may be calculated from step 42 (FIGS. 5,7). The term D_{LTreas} may be calculated from step 40. The duration factor for the long U.S. Treasury portfolio asset class may be computed using a long U.S. Treasury index duration or equivalent.

The 30 year interest rate swap asset class is built using an equal weighting of general rate volatility and swap spread volatility with a duration factor applied. The following equation may be used to compute volatility associated with the 30 year interest rate swap asset class.

$${σ}_{IR}^{2} = {σ}_{Tsy}^{2} {D}_{IR}^{2} + {σ}_{IRSpread}^{2} {D}_{IR}^{2} + 2 {σ}_{IRSpread} {σ}_{Tsy} {D}_{IC} {D}_{IC} {ρ}_{TsyIR , IRSpread}$$

The terms σ²_{Tsy}, σ²_{IRSpread}, σ_{IRSpread}, σ_{Tsy} may be calculated from step 42 (FIG. 5,7). The term ρ_{TsyIR,IRSpread} may be calculated from step 44 (FIG. 6,8). The duration factor for the 30 year interest rate swap asset class (D_{IR}) is the duration of a 30 year interest rate swap.

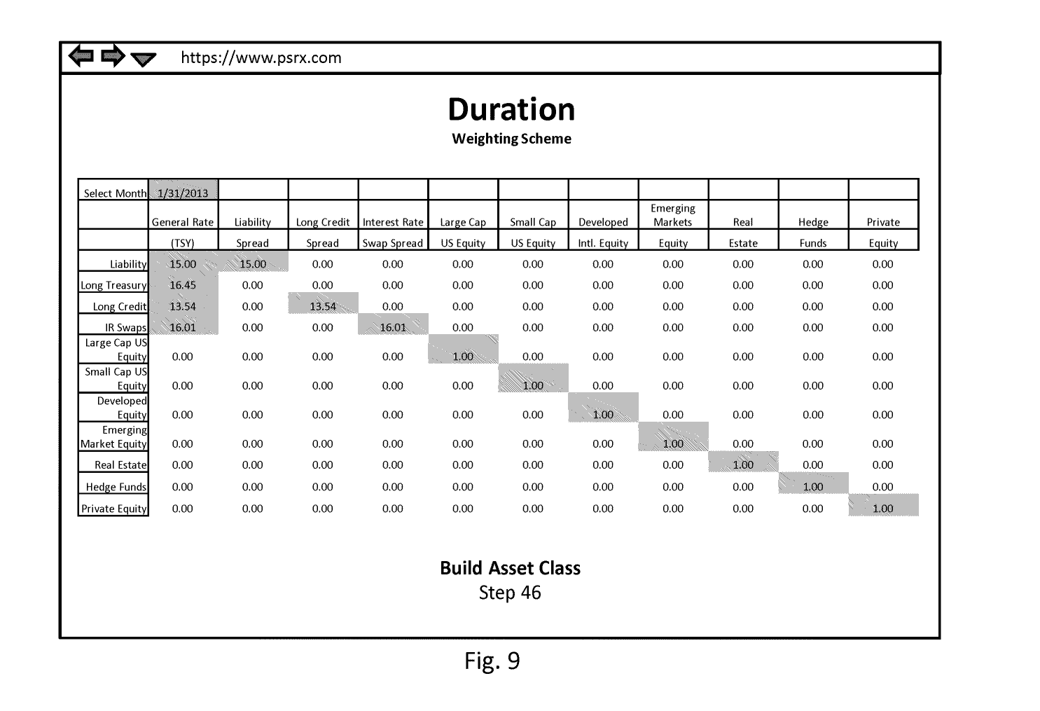

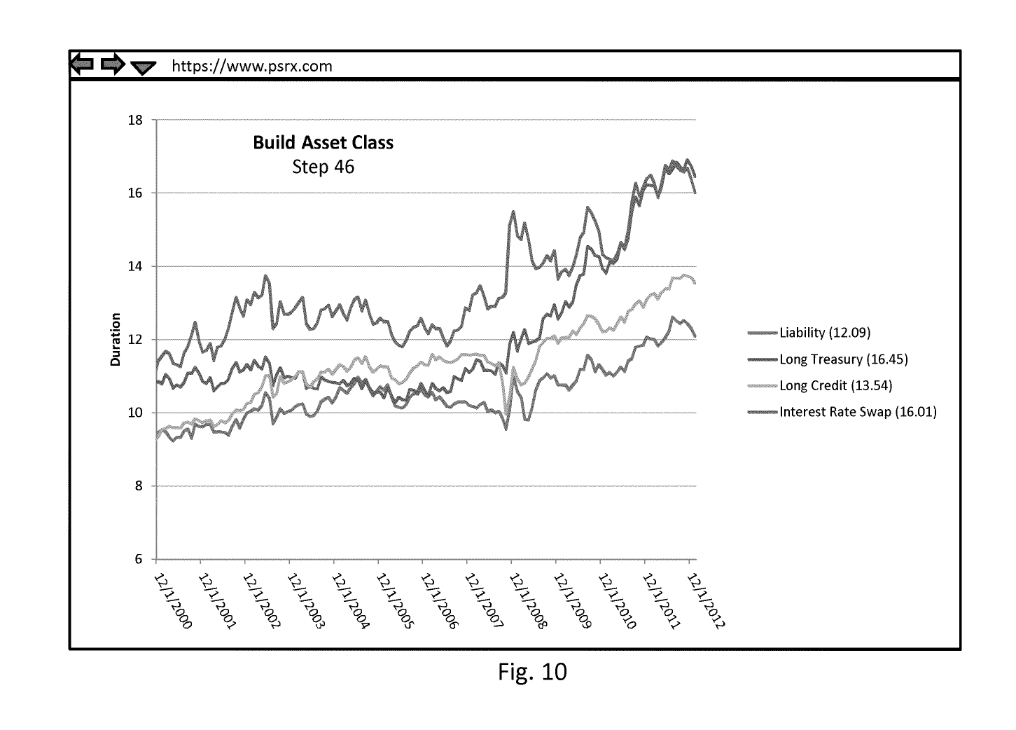

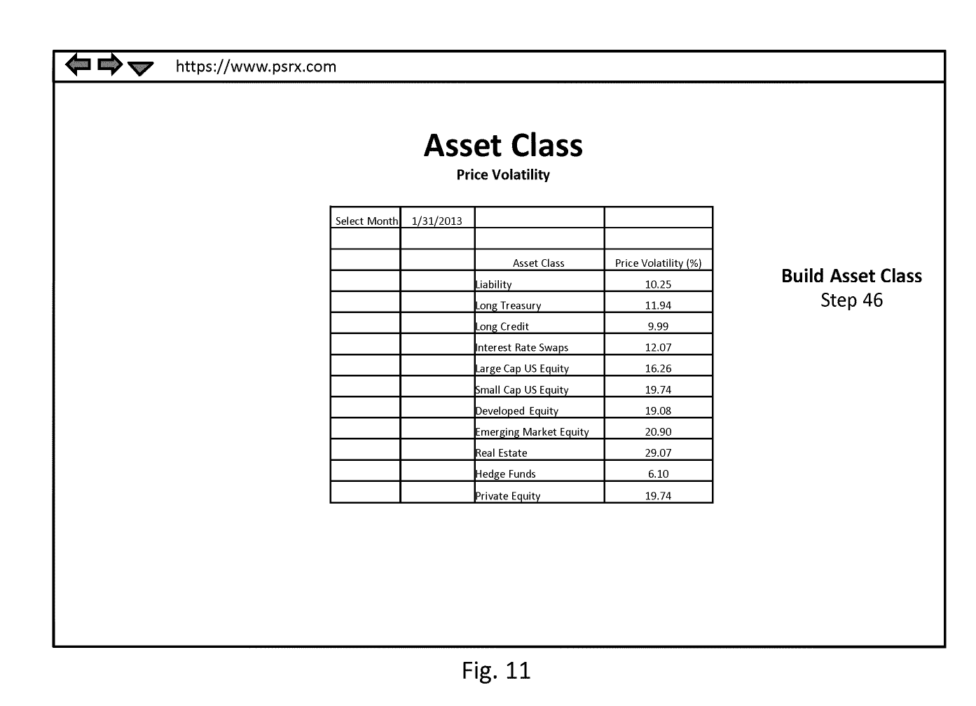

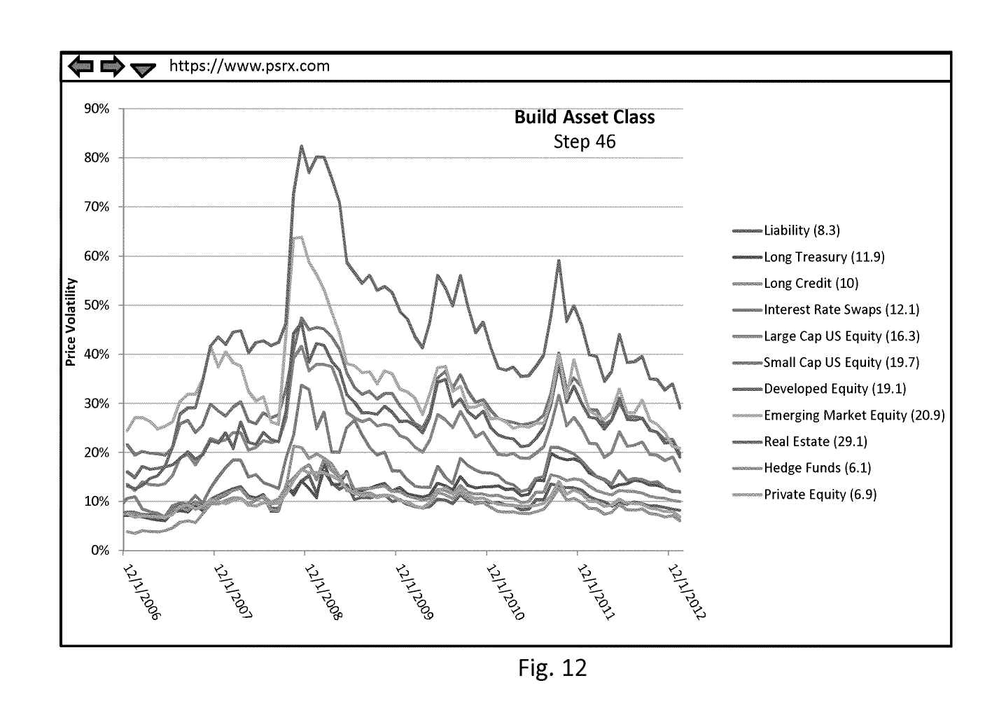

FIGS. 9-12 show exemplary displays that may be displayed at workstation to show data associated with the steps in building the asset classes. FIG. 9 shows, in tabular form, the duration factors that may be applied for a specific date. FIG. 10 shows in graphical form duration factors that may be applied for a range of historical dates. FIG. 11 shows in chart form, for a specific date, the volatilities associated with the asset classes after the weighting scheme and duration factors are applied. FIG. 12 shows in graphical form volatilities associated with the asset classes after the weighting scheme and duration factors are applied for a range of historical dates.

As mentioned above, after the asset classes are built, the portfolio volatility is constructed. At step 50, the system receives the asset class data computed at step 46 and portfolio inputs computed at step 48. The system applies the asset class data and portfolio inputs to the securities and other assets maintained in the portfolio based upon the percentage of the holdings in the portfolio. In building the portfolio, the portfolio asset classes must equal the funded status of the plan. For instance, as shown in the example below and not in any limiting sense, a portfolio with an allocation of 20% holdings in long credit assets, 20% holdings in long U.S. Treasury assets, and 60% in other assets is shown as:

$$V = [ \begin{matrix}Liability Volatility ( Liab ) \\ Long Treasury Volatility ( L T ) \\ Long Credit Volatility ( L C ) \\ Large Cap US Equity Volatility ( L C E ) \\ Small Cap US Equity Volatility ( S C E ) \\ International Equity Volatility ( I E ) \\ Emerging Market Equity Volatility ( E M ) \\ Real Estate Volatlity ( R E ) \\ Hedge Funds Volatility ( HF ) \\ Private Equity Volatility ( P E )\end{matrix} ]$$

$$C = [ \begin{matrix}{corr}_{Liab , Liab} & {corr}_{Liab , LT} & {corr}_{Liab , LC} & {corr}_{Liab , LCE} & {corr}_{Liab , SCE} & {corr}_{Liab , IE} & {corr}_{Liab , EM} & {corr}_{Liab , RE} & {corr}_{Liab , HF} & {corr}_{Liab , PE} \\ {corr}_{LT , Liab} & … & … & … & … & … & … & … & … & … \\ {corr}_{LC , Liab} & … & … & … & … & … & … & … & … & … \\ {corr}_{LCE , Liab} & … & … & … & … & … & … & … & … & … \\ {corr}_{SCE , Liab} & … & … & … & … & … & … & … & … & … \\ {corr}_{IE , Liab} & … & … & … & … & … & … & … & … & … \\ {corr}_{EM , Liab} & … & … & … & … & … & … & … & … & … \\ {corr}_{RE , Liab} & … & … & … & … & … & … & … & … & … \\ {corr}_{HF , Liab} & … & … & … & … & … & … & … & … & … \\ {corr}_{PE , Liab} & … & … & … & … & … & … & … & … & …\end{matrix} ]$$

$$X = {VV}^{′} * C ( {Where }^{{ }^{″} {★}^{″}} is an element by element multiplication of two matrices )$$

$$W = [ \begin{matrix}\% Liability ( Liab ) \\ \% Long Treasury ( L T ) \\ \% Long Credit ( L C ) \\ \% Large Cap US Equity ( L C E ) \\ \% Small Cap US Equity ( S C E ) \\ \% International Equity ( I E ) \\ \% Emerging Market Equity ( E M ) \\ \% Real Estate ( R E ) \\ \% Hedge Funds ( HF ) \\ \% Private Equity ( P E )\end{matrix} ]$$

$$X = [ \begin{matrix}{cov}_{Liab , Liab} & {cov}_{Liab , LT} & {cov}_{Liab , LC} & {cov}_{Liab , LCE} & {cov}_{Liab , SCE} & {cov}_{Liab , IE} & {cov}_{Liab , EM} & {cov}_{Liab , RE} & {cov}_{Liab , HF} & {cov}_{Liab , PE} \\ {cov}_{LT , Liab} & … & … & … & … & … & … & … & … & … \\ {cov}_{LC , Liab} & … & … & … & … & … & … & … & … & … \\ {cov}_{LCE , Liab} & … & … & … & … & … & … & … & … & … \\ {cov}_{SCE , Liab} & … & … & … & … & … & … & … & … & … \\ {cov}_{IE , Liab} & … & … & … & … & … & … & … & … & … \\ {cov}_{EM , Liab} & … & … & … & … & … & … & … & … & … \\ {cov}_{RE , Liab} & … & … & … & … & … & … & … & … & … \\ {cov}_{HF , Liab} & … & … & … & … & … & … & … & … & … \\ {cov}_{PE , Liab} & … & … & … & … & … & … & … & … & …\end{matrix} ]$$

$${σ}_{Portfolio}^{2} = {WXW}^{′}$$

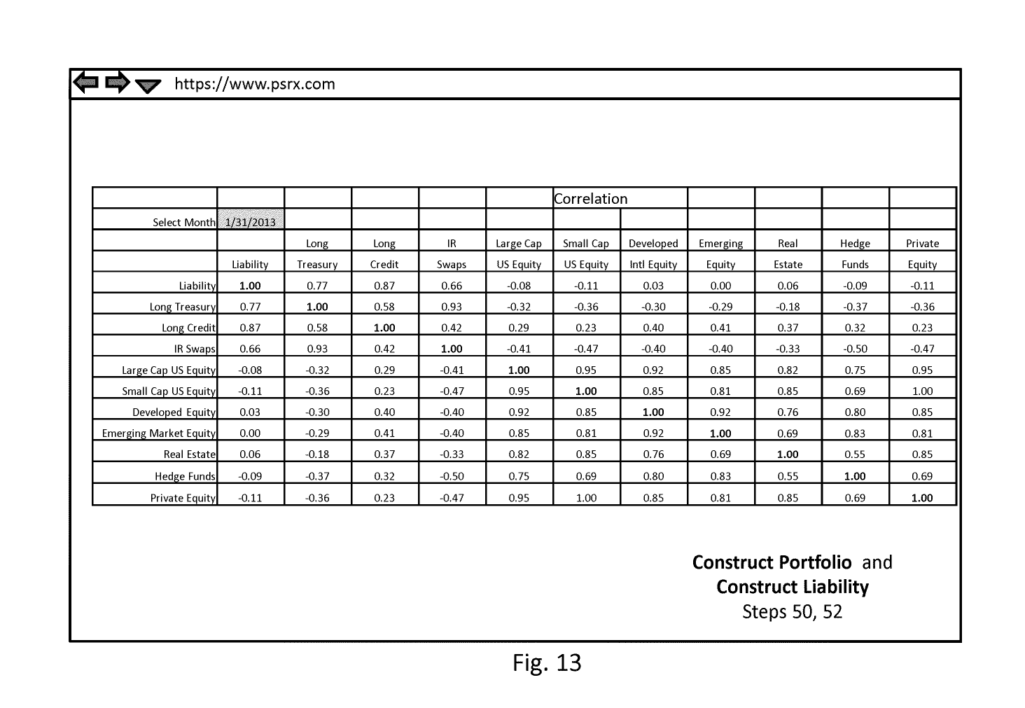

The terms σ²_{LTreas}, σ²_{LC}, σ²_{EQY}, σ_{LTreas}, σ_{LC}, σ_{EQY} may be calculated from step 46 (FIGS. 11,12). The terms ρ_{LTreas,EQY}, ρ_{LTreas,LC}, ρ_{LC,EQY} may be calculated from step 44 (FIG. 13), and W_{Liab}=0% W_{LC}=20%, W_{LTreas}20%, W_{LCEQ}=20%, Ws_{CEQ}=5%, W_{INEQ}=15%, W_{EMEQ}=5%, W_{RE}=5%, W_{HF}=5%, and W_{PE}=5%.

As mentioned above, at step 52, the system receives the asset class data computed at step 46 and liability inputs as computed in step 49 and applies the data to the liability asset class. The liability volatility is the same as calculated in step 46.

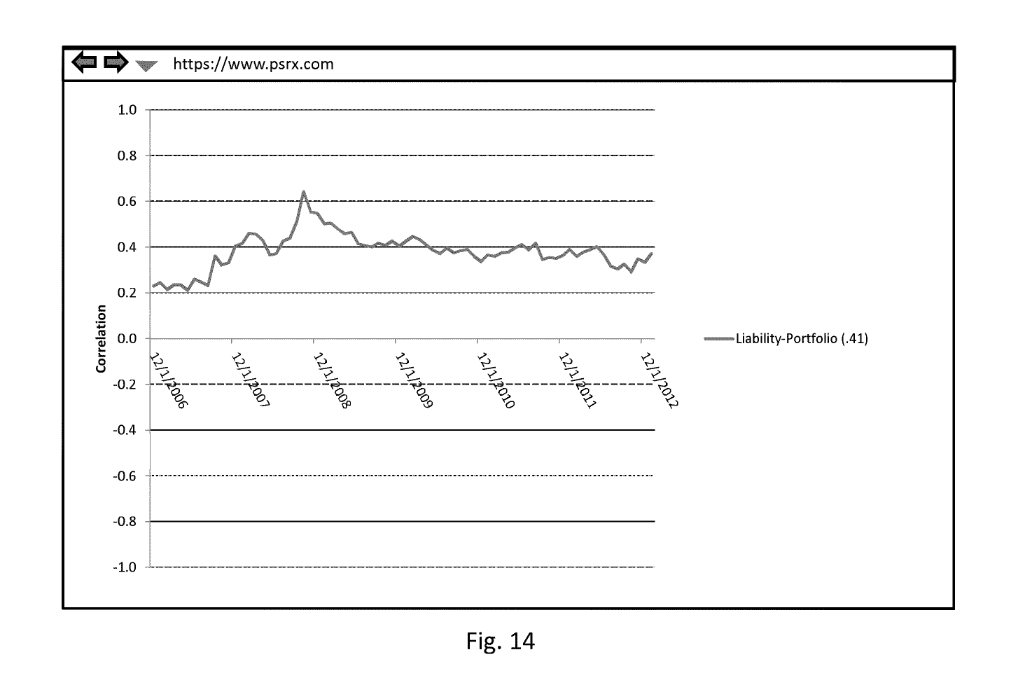

FIGS. 13-14 show exemplary data displays that may be displayed at workstation 24. FIG. 13 shows in chart form for a specified date, the correlation factors associated with the liability and the portfolio asset classes as constructed in steps 52 and 50. FIG. 14 shows in graphical form the correlation of the liability to portfolio.

Then at step 54, the system calculates funded status volatility through the statistical subtraction of the portfolio and the liability using the following equation:

σ²_{FS}=σ²_{Portfolio}*FundedStatus %²+σ²_{Liability}−2σ_{Portfolio}*σ_{Liability}*FundedStatus %*ρ_{Portfolio,Liability}

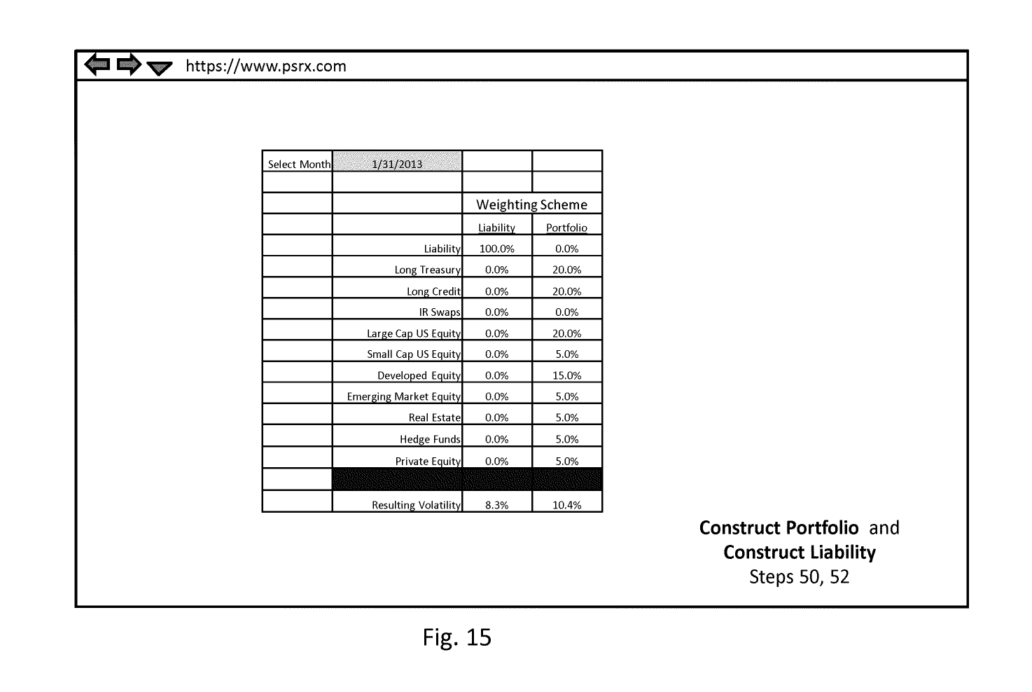

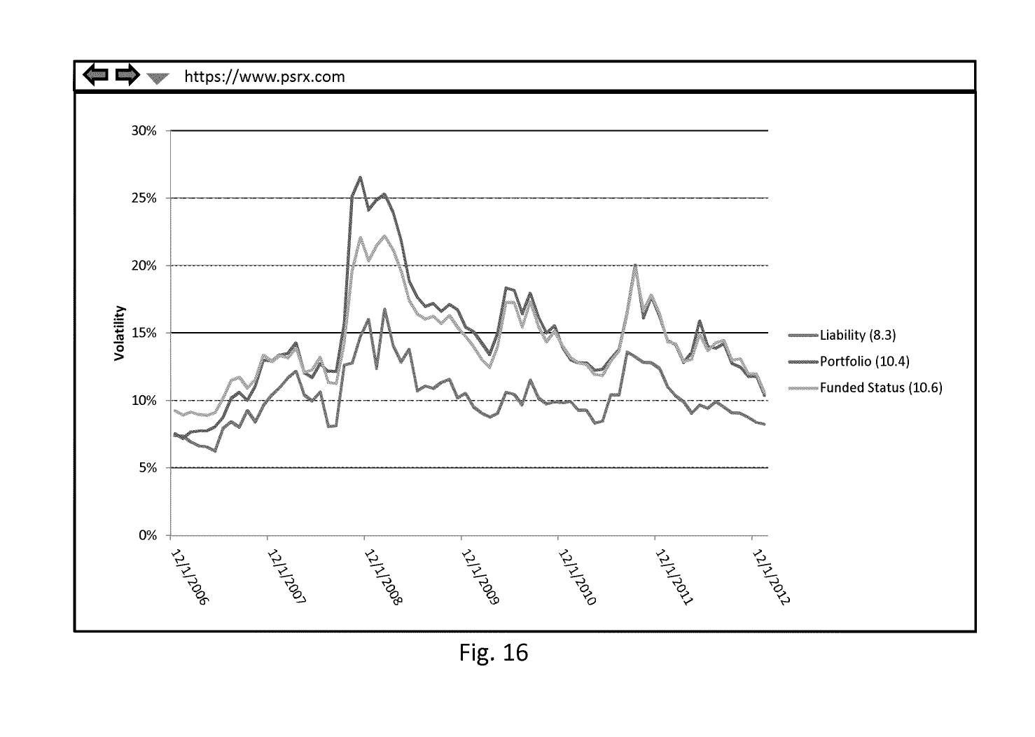

The terms σ²_{Portfolio}, ρ²_{Liability}, σ_{Portfolio}, σ_{liability} may be calculated at step 50 (FIG. 15-16). The term FundedStatus % may be calculated from step 48. The term ρ_{Portfolio,Liability} may be calculated from step 50 and 52 (FIG. 13,14) according to the following formula:

$$cov ( Portfolio , Liability ) = {W}_{portfolio} {CW}_{liability}^{′}$$

$${ρ}_{Portfolio , Liabity} = \frac{cov ( Portfolio , Liability )}{{σ}_{Portfolio} \cdot {σ}_{Liability}}$$

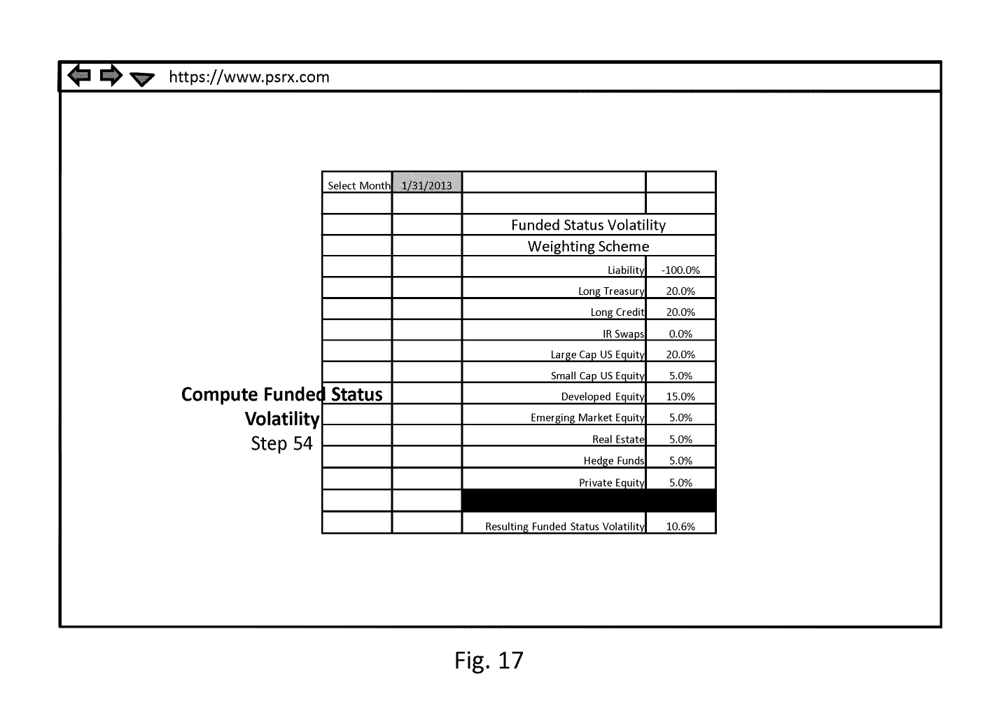

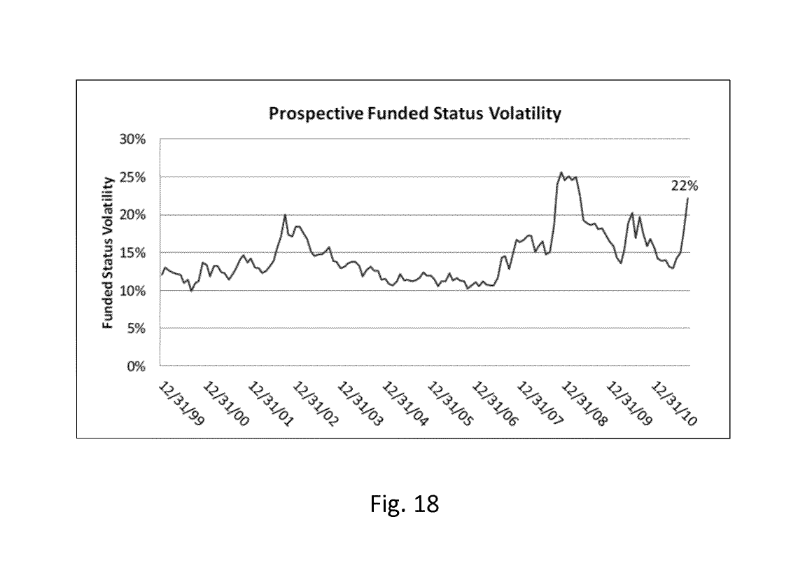

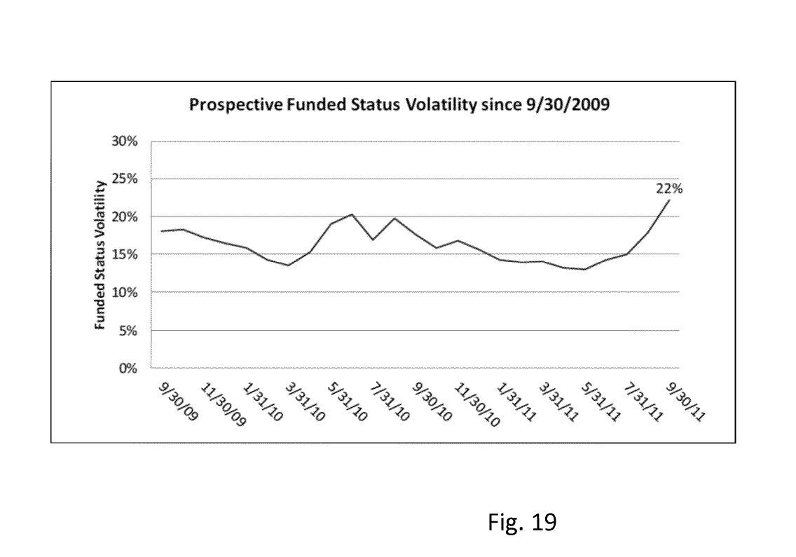

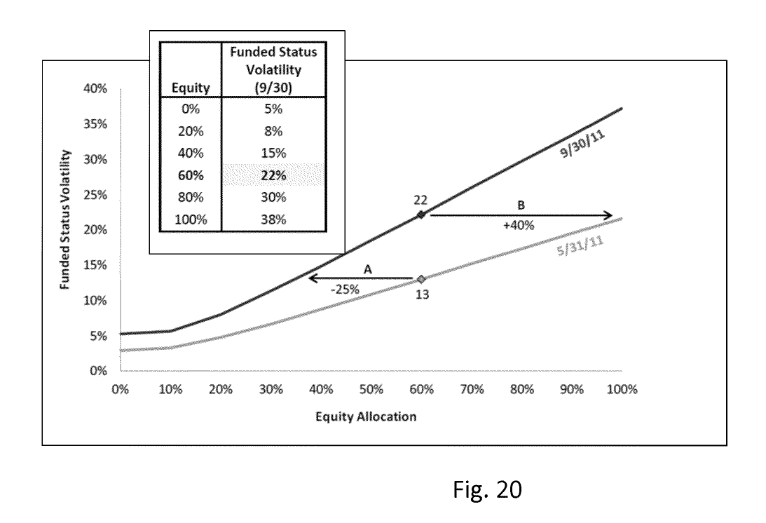

FIGS. 15-17 show exemplary graphs that may be displayed at workstation 24. FIG. 15 shows in chart form for a specific date resulting volatility for the asset classes, i.e., 8.3% for the liability and 10.4% for the portfolio. FIG. 16 shows in graphical form resultant volatilities associated with the portfolio, the liability, and funded status. FIG. 17 shows in chart form the resultant index of funded status volatility (i.e., 10.6%) that may be transmitted to users via the system 20. The funded status volatility may be used as an index and displayed as may be desired by a user or subscriber.

While the present invention may be embodied in many different forms, a number of illustrative embodiments are described herein with the understanding that the present disclosure is to be considered as providing examples of the principles of the invention and such examples are not intended to limit the invention to the embodiments shown or described herein.

What is claimed is:

1. A system for assessing a level of volatility associated with a funding level of a pension fund and similar funds, the system comprising:
a memory;
a processor configured to:
store a plurality of data structures in the memory, the data structures comprising a plurality of (1) data items associated together as volatility measures, (2) data items associated together as a correlation measures, the correlation measures corresponding to correlation of the volatility measures; (3) data items associated together as a duration measures, the duration measures being related to the volatility measures; and (4) data items associated together relating to a holding in the fund;
determine an asset class volatility measure based in part upon the volatility measures, the correlation measures, the duration measures, and the holding in the fund;
determine a liability measure associated with the fund;
determine a holding volatility measure based upon the asset class volatility measure and the holding in the fund; and
calculate a funded status volatility by a statistical comparison of the holding volatility measure to the liability measure.

2. The system of claim 1 wherein the fund has a plurality of holdings and the processor is further configured to determine: (1) a plurality of asset class volatilities relating to the holdings; and (2) holding volatility measures for each holding in the fund based upon the asset class volatilities relating to the holding and the percentage weight of the holding in the fund.

3. The system of claim 1, wherein a portion of the data items associated with the volatility measures is based upon objective financial market data.

4. The system of claim 1, wherein the processor is further configured to transmit the calculated funded status volatility over a network.

5. The system of claim 1, wherein the processor is configured to communicate with a data source to obtain data related to market financial information.

6. The system of claim 1, wherein the data items associated with the volatility measure are obtained from the data source.

7. The system of claim 1, wherein a portion of the data items associated with the duration measures is obtained from the data source.

8. The system of claim 1 wherein the volatility measures comprise at least one of: (1) general rate volatility, (2) interest rate swap volatility, (3) long credit spread volatility and (4) liability spread volatility.

9. The system of claim 1 further comprising a server, wherein the processor and memory are resident on the server.

10. The system of claim 9 wherein the server comprises a plurality of networked servers, at least one of the servers hosting a website for enabling a user to receive the calculated funded status.

11. A method for assessing a level of volatility associated with a funding level of a pension fund and similar funds, the method comprising:
storing a data structure in a memory, the data structure comprising a plurality of (1) data items associated together as volatility measures, (2) data items associated together as a correlation measures, the correlation measures corresponding to correlation of the volatility measures; (3) data items associated together as a duration measures, the duration measures being related to the volatility measures; and (4) data items associated together as holdings in the fund;
determining a plurality of asset class volatility measures for each of the holdings in the fund, each asset class volatility measure based in part upon the volatility measures, the correlation measures, the duration measures, and the holdings in the fund;
determining a liability measure associated with the fund;
determining a holding volatility measure for each holding in the fund based upon the asset class volatilities relating to the holding and the percentage weight of the holding in the fund; and
calculating a funded status volatility by comparing the holding volatility measure to the liability measure; and
wherein the method steps are performed by a processor.

12. A system for assessing a level of volatility associated with a funding level of a pension fund and similar funds, the system comprising:
a memory;
a processor configured to:
store a data structure comprising a plurality of data items associated together as volatility measures;
store a data structure comprising a plurality of data items associated together as a correlation measures, the correlation measures corresponding to correlation of asset returns within the fund;
store a data structure comprising a plurality of data items associated together as a duration measures, the duration measures corresponding to the volatility measures;
store a data structure comprising a plurality of data items associated together as holdings in the fund;
determine a plurality of asset class volatility measures for each of the holdings in the fund, each asset class volatility measure based in part upon the volatility measures, the correlation measures, the duration measures and the holdings in the fund;
determine a holding volatility measures for each holding in the fund based upon the asset class volatilities relating to the holding and the percentage weight of the holding in the fund.
determine a liability measure associated with the fund;
calculate a funded status volatility by comparing the holding volatility measures for each holding in the fund to the liability measure.

13. The system of claim 12, wherein a portion of the data items associated with the volatility measures is based upon objective financial market data.

14. The system of claim 12, wherein a portion of the data items associated with the volatility measures is based upon historical financial market data.

15. The system of claim 12, wherein the processor is further configured to transmit the calculated funded status volatility over a network.

16. The system of claim 12, wherein the data items associated with the volatility measure are representative of (1) a fixed income portfolio, (2) a general rate, (3) an interest rate swap, and (4) a risk asset portfolio.

17. The system of claim 12, wherein a portion of the data items associated with the duration measures is based upon historical financial market data.

18. The system of claim 12, wherein a portion of the data items associated with the duration measures is based upon objective financial market data.

19. The system of claim 12, further comprising a server hosting a website for enabling a user to receive the calculated funded status.

20. The system of claim 12, wherein the processor comprises a plurality of processors.
